(19) United States
(12) Patent Application Publication
(10) Pub. No.: US 2013/0009500 A1
(43) Pub. Date: Jan. 10, 2013

(54) SPINDLE MOTOR

(75) Inventor: Dong Hyun LEE, Seoul (KR)

(73) Assignee: SAMSUNG ELECTRO-MECHANICS CO., LTD., Suwon (KR)

(21) Appl. No.: 13/523,201

(22) Filed: Jun. 14, 2012

(30) Foreign Application Priority Data
Jul. 4, 2011 (KR) 10-2011-0066002

(51) Int. Cl. H02K 7/08

(52) U.S. Cl. 310/90

(57) ABSTRACT

There is provided a spindle motor including: a sleeve including a shaft rotatably mounted therein and a circulation hole formed therein; and a cover member mounted on a lower end portion of the sleeve and including an opening/closing part opening and closing the circulation hole.

### CROSS-REFERENCE TO RELATED APPLICATIONS

This application claims the priority of Korean Patent Application No. 10-2011-0066002 filed on Jul. 4, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor including a cover member.

2. Description of the Related Art

A small spindle motor used in a hard disk drive (HDD) is generally provided with a fluid dynamic bearing assembly, and a bearing clearance formed between a shaft and a sleeve configuring the fluid dynamic bearing assembly is filled with a lubricating fluid such as oil. The lubricating fluid filling the bearing clearance generates fluid dynamic pressure while being pumped, thereby rotatably supporting the shaft.

Meanwhile, a bearing clearance may also be formed between an upper surface of the sleeve and a lower surface of a rotor hub or between a lower surface of the sleeve and a cover member mounted on a lower end portion of the sleeve.

All of the bearing clearances formed as described above are filled with the lubricating fluid.

The sleeve may include a circulation hole formed therein in order to discharge air bubbles, contained in the lubricating fluid filling the above-mentioned bearing clearances, to the outside. That is, the circulation hole is formed in the sleeve to thereby discharge air bubbles contained in the lubricating fluid filling the above-mentioned bearing clearances to the outside.

In addition, the circulation hole serves to adjust pressure in the above-mentioned bearing clearances. In other words, the circulation hole may be formed in the sleeve in order to adjust pressures between upper and lower surfaces of the sleeve.

However, at the time of initial driving of the shaft, an increase in pressure in the bearing clearance formed by the lower surface of the sleeve and the cover member may be hindered by the circulation hole formed in the sleeve. That is, at the time of initial driving of the shaft, the lubricating fluid is introduced into the bearing clearance formed by the lower surface of the sleeve and the cover member, such that pressure in the bearing clearance increases; however, the lubrication fluid may be introduced into the circulation hole, such that the increase in pressure is hindered.

Therefore, a floating period of the shaft increases.

### SUMMARY OF THE INVENTION

An aspect of the present invention provides a spindle motor capable of reducing a floating time of a shaft at the time of initial driving of the shaft.

According to an aspect of the present invention, there is provided a spindle motor including: a sleeve including a shaft rotatably mounted therein and a circulation hole formed therein; and a cover member mounted on a lower end portion of the sleeve and including an opening/closing part opening and closing the circulation hole.

The cover member may be formed of a material having elasticity so that the opening/closing part may open and close the circulation hole.

The opening/closing part may be formed of a protrusion inserted into an inner portion of the circulation hole.

The circulation hole may include a chamfer part formed at a lower end portion thereof so that the opening/closing part may be easily inserted thereinto.

The sleeve may include upper and lower dynamic pressure grooves formed in an inner peripheral surface thereof so that fluid dynamic pressure may be generated through lubricating fluid filling a bearing clearance formed by the shaft and the sleeve at the time of rotation of the shaft, and the lubricating fluid filling the bearing clearance may move from the bearing clearance to a bearing clearance formed by the cover member and the shaft and by the cover member and the sleeve at the time of the rotation of the shaft.

The sleeve may include a plurality of circulation holes formed therein in a radial direction, and a plurality of opening/closing parts corresponding to the plurality of circulation holes may be provided so as to open and close the plurality of circulation holes.

The spindle motor may further include a thrust plate fixedly mounted to the shaft so as to be disposed at an upper portion of the sleeve.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is a partially cut-away, exploded perspective view showing a shaft, a sleeve, and a cover member included in a spindle motor according to an embodiment of the present invention;

FIG. 3 is an enlarged view of part A of FIG. 1;

FIG. 4 is a view describing an operation of a spindle motor according to an embodiment of the present invention;

FIG. 5 is a cross-sectional view schematically showing a spindle motor according to another embodiment of the present invention;

FIG. 6 is a cross-sectional view schematically showing a spindle motor according to another embodiment of the present invention; and

FIG. 7 is a view describing an operation of a spindle motor according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

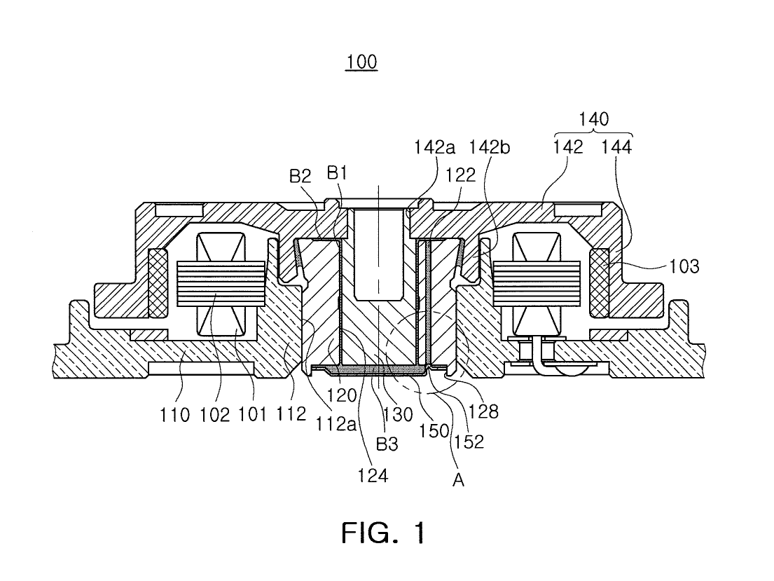

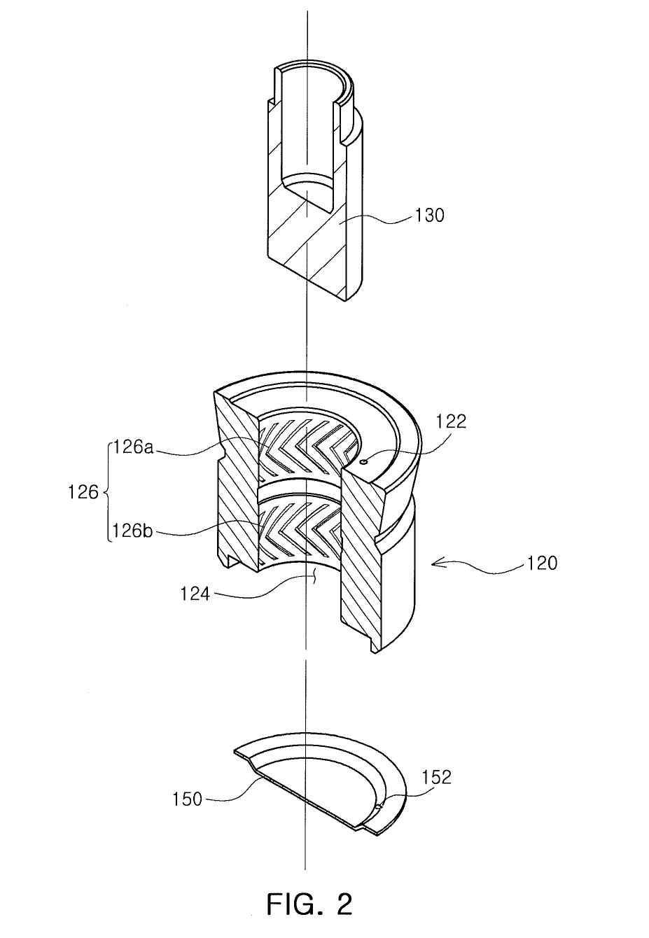

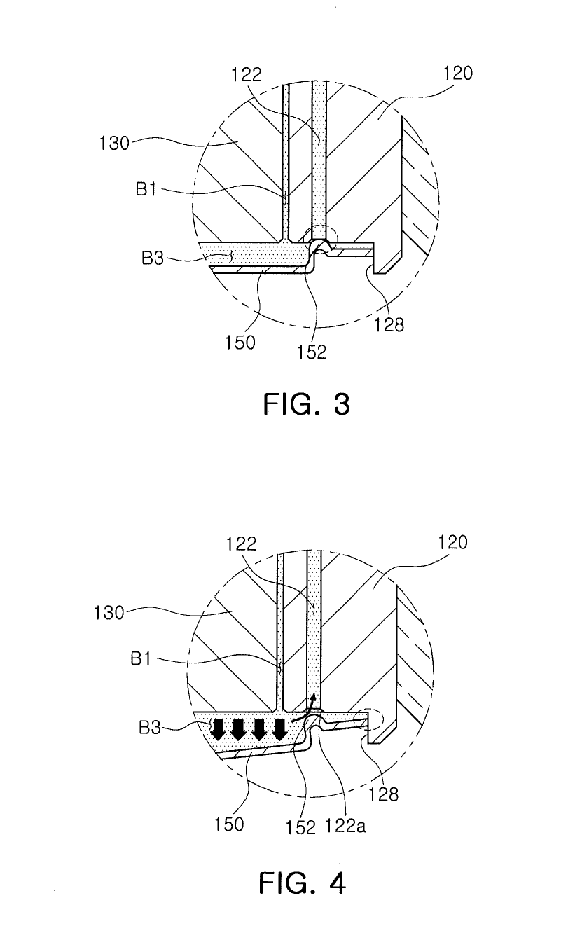

FIG. 1 is a cross-sectional view schematically showing a spindle motor according to an embodiment of the present invention; FIG. 2 is a partially cut-away, exploded perspective view showing a shaft, a sleeve, and a cover member included in a spindle motor according to an embodiment of the present invention; FIG. 3 is an enlarged view of part A of FIG. 1; and FIGS. 4 is a view describing an operation of a spindle motor according to an embodiment of the present invention.

Referring to FIGS. 1 through 4, a spindle motor 100 according to an embodiment of the present invention may include, for example, a base member 110, a sleeve 120, a shaft 130, a rotor hub 140, and a cover member 150.

Terms with respect to directions will be first defined. As viewed in FIG. 1, an axial direction refers to a vertical direction, that is, a direction from a lower end portion of the shaft 130 toward an upper end portion thereof or a direction from the upper end portion of the shaft 130 toward the lower end portion thereof, a radial direction refers to a horizontal direction, that is, a direction from an outer peripheral surface of the rotor hub 140 toward the shaft 130 or a direction from the shaft 130 to the outer peripheral surface of the rotor hub 140, and a circumferential direction refers to a direction in which the rotor hub 140 rotates along the outer peripheral surface thereof.

The base member 110 may include a sleeve housing 112 having the sleeve 120 mounted therein. The sleeve housing 112 protrudes upwardly in an axial direction and includes a mounting hole 112a formed therein so that the sleeve 120 may be insertedly mounted therein.

Meanwhile, the sleeve housing 112 may include a stator core 102 fixedly mounted on an outer peripheral surface thereof, wherein the stator core 102 has a coil 101 wound therearound.

The sleeve 120 may include the shaft 130 rotatably mounted therein. In addition, the sleeve 120 may include a circulation hole 122 formed therein.

The sleeve 120 may be fixedly mounted in the base member 110. That is, the sleeve 120 is fixedly mounted in the sleeve housing 112. More specifically, the sleeve 120 may be insertedly mounted in the mounting hole 112a.

That is, the outer peripheral surface of the sleeve 120 and an inner peripheral surface of the sleeve housing 112 may be bonded to each other by an adhesive and/or welding.

Meanwhile, an inner surface of the sleeve 120 may have a shape corresponding to that of an outer surface of the shaft 130. That is, the sleeve 120 may include a through-hole 124 having a shape corresponding to that of the shaft 130 so that the shaft 130 may be mounted therein while penetrating therethrough.

In addition, the sleeve 120 may include a dynamic pressure groove 126 formed in the inner surface thereof so that fluid dynamic pressure may be generated at the time of rotation of the shaft 130. The dynamic pressure groove 126 may include an upper dynamic pressure groove 126a formed at an upper portion of the sleeve 120 and a lower dynamic pressure groove 126b disposed under the upper dynamic pressure groove 126a.

A detailed description of the circulation hole 122 will be provided below.

The shaft 130 may be rotatably mounted in the sleeve 120. In addition, when the shaft 130 is mounted in the sleeve 120, an outer peripheral surface of the shaft 130 and an inner peripheral surface of the sleeve 120 are disposed to be spaced apart from each other by a predetermined interval to thereby form a bearing clearance B1 therebetween. Lubricating fluid may be filled in the bearing clearance B1.

Meanwhile, at the time of the rotation of the shaft 130, the lubricating fluid filling the bearing clearance B1 is pumped by the upper and lower dynamic pressure grooves 126a and 126b formed in the sleeve 120 described above, such that fluid dynamic pressure is generated. At this time, a portion of the lubricating fluid filling the bearing clearance B1 moves downwardly from the bearing clearance B1.

In addition, the shaft 130 may include the rotor hub 140 fixedly mounted on an upper end portion thereof, and rotate together with the rotor hub 140 at the time of rotation of the rotor hub 140.

In addition, the rotor hub 140 may include a body 142 having a mounting hole 142a formed therein so that the shaft 130 may be mounted therein while penetrating therethrough, and a magnet mounting part 144 extended downwardly from an edge of the body 142 in an axial direction.

In addition, the magnet mounting part 144 may include a magnet 103 mounted on an inner surface thereof, wherein the magnet 103 may be disposed to face an end of the stator core 102.

Meanwhile, the magnet 103 may have an annular ring shape and be a permanent magnet generating magnetic force having a predetermined strength by alternately magnetizing an N pole and an S pole thereof in a circumferential direction.

Here, rotational driving of the rotor hub 140 will be schematically described. When power is supplied to the coil 101 wound around the stator core 102, driving force capable of rotating the rotor hub 140 by electromagnetic interaction between the magnet 103 and the stator core 102 having the coil 101 wound therearound is generated.

Therefore, when the rotor hub 140 rotates, the shaft 130 to which the rotor hub 140 is fixedly coupled also rotates together with the rotor hub 140.

Meanwhile, the body 142 of the rotor hub 140 may include an extension wall part 142b extended downwardly from a lower surface thereof in an axial direction. The extension wall part 142b serves to form an interface between the lubricating fluid and air together with the outer peripheral surface of the sleeve 120.

In addition, a lower surface of the rotor hub 140, in other words, the lower surface of the body 142 and an upper surface of the sleeve 120 may be disposed to be spaced apart from each other by a predetermined interval to thereby form a bearing clearance B2 therebetween. The lubricating fluid may be also filled in this bearing clearance B2 and filled up to a space formed by the extension wall part 142b and the outer peripheral surface of the sleeve 120.

The cover member 150 may be mounted on a lower end portion of the sleeve 120 and include an opening/closing part 152 formed therein, wherein the opening/closing part 152 opens and closes the circulation hole 122.

That is, the cover member 150 may be fixedly mounted in a mounting groove 128 depressed in the lower end portion of the sleeve 120 by an adhesive and/or welding. In addition, when the cover member 150 is mounted on the sleeve 120, a bearing clearance B3 may be formed by the cover member 150 and the sleeve 120 and by the cover member 150 and the shaft 130. The lubricating fluid may be also filled in the this bearing clearance B3.

Meanwhile, the cover member 150 serves to prevent the lubricating fluid filling the bearing clearance B3 from being leaked downwardly of the sleeve 120.

In addition, the cover member 150 may be formed of a material having elasticity so that the opening/closing part 152 may open and close the circulation hole 122. That is, the cover member 150 may be formed of a material having the elasticity, so that when pressure in the bearing clearance B3 increases at the time of the rotation of the shaft 130, the cover member 150 is elastically deformed, such that the opening/closing part 152 may open and close the circulation hole 122.

Meanwhile, the opening/closing part 152 may be formed of a protrusion inserted into an inner portion of the circulation hole 122. That is, the opening/closing part 152 may protrude upwardly in the axial direction and be formed of the protrusion having a shape corresponding to that of the circulation hole 122.

In addition, the circulation hole 122 may include a chamfer part 122a (See FIG. 4) formed at a lower end portion thereof so that the opening/closing part 152 may be easily inserted thereinto.

As described above, when the shaft 130 does not rotate, the opening/closing part 152 is in a state in which it is inserted into the circulation hole 122 as shown in FIG. 3. Therefore, the lower end portion of the circulation hole 122 is closed by the opening/closing part 152.

Thereafter, when the shaft 130 rotates, the lubricating fluid filling the bearing clearance B1 formed by the sleeve 120 and the shaft 130 moves to the bearing clearance B3 formed by the cover member 150, the sleeve 120 and the shaft 130, by the dynamic pressure groove 126 formed in the sleeve 120.

In addition, at the time of initial driving of the shaft 130, the pressure in the bearing clearance B3 does not arrive at pressure elastically deforming the cover member 150, such that the lower end portion of the circulation hole 122 is maintained in a state in which it is closed.

Thereafter, when the shaft 130 continuously rotates, the pressure in the bearing clearance B3 arrives at pressure capable of floating the shaft 130.

Thereafter, when the shaft 130 continuously rotates, the pressure in the bearing clearance B3 arrives at pressure elastically deforming the cover member 150, such that the opening/closing part 152 opens the lower end portion of the circulation hole 122 as shown in FIG. 4.

In other words, the opening/closing part 152 closes the lower end portion of the circulation hole 122 until the shaft 130 is floated, and opens the lower end portion of the circulation hole 122 when the shaft 130 is floated. Therefore, the circulation hole 122 serves to discharge air bubble and adjust pressure in the bearing clearances B1, B2, and B3.

As a result, the opening/closing part 152 closes the lower end portion of the circulation hole 122 at the time of the initial driving of the shaft 130 to thereby allow the pressure in the bearing clearance B3 to rapidly increase. Therefore, a floating time of the shaft 130 may be reduced.

In addition, the shaft 130 may be easily floated even when the shaft 130 rotates at a low speed.

Hereinafter, a spindle motor according to another embodiment of the present invention will be described with reference to the accompanying drawings.

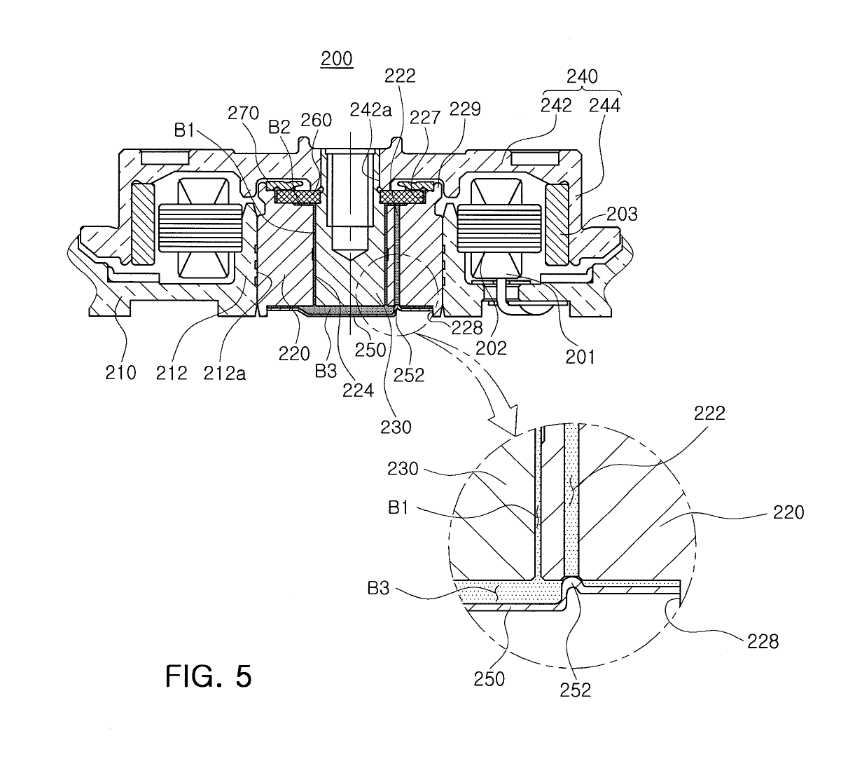

FIG. 5 is a cross-sectional view schematically showing a spindle motor according to another embodiment of the present invention.

Referring to FIG. 5, a spindle motor 200 according to another embodiment of the present invention may include abase member 210, a sleeve 220, a shaft 230, a rotor hub 240, a cover member 250, a thrust plate 260, and a cap member 270.

Meanwhile, the base member 210 is the same component as the base member 110 of the spindle motor 100 according to the embodiment of the present invention described above. Therefore, a detailed description thereof will be omitted below and be replaced by the above-mentioned description.

The sleeve 220 maybe fixedly mounted in a mounting part 212 of the base member 210 . That is, an outer peripheral surface of the sleeve 220 may be bonded to an inner peripheral surface of the mounting part 212 by an adhesive or the sleeve 220 may be press-fitted into the mounting part 212.

In addition, the sleeve 220 may include a circulation hole 222 formed therein.

Meanwhile, the sleeve 220 may include a through-hole 224 formed therein so that the shaft 230 may be insertedly mounted therein. That is, the sleeve 220 may have a hollow cylindrical shape.

Meanwhile, when the shaft 230 is mounted in the sleeve 220, an inner peripheral surface of the sleeve 220 and an outer peripheral surface of the shaft 230 are spaced apart from each other by a predetermined interval to thereby form a bearing clearance B1 therebetween. Lubricating fluid is filled in the bearing clearance B1.

In addition, the sleeve 220 may include a dynamic pressure groove (See FIG. 2) formed in the inner surface thereof so as to pump the lubricating fluid filling the bearing clearance B1 at the time of rotation of the shaft 230 to thereby generate fluid dynamic pressure.

In addition, the sleeve 220 may include the cover member 250 mounted on a lower portion thereof in order to prevent the lubricating fluid from being leaked downwardly. That is, the sleeve 220 may include a mounting groove 228 depressed upwardly in a lower end portion thereof so that the cover member 250 may be mounted thereon.

Meanwhile, the sleeve 220 may include an insertion groove 227 formed at an upper end portion thereof, wherein the insertion groove 227 has the thrust plate 260 inserted thereinto. The insertion groove 227 may include an outer wall part 229 formed on an outer portion thereof so that the cap member 270 is fixedly mounted thereto.

The shaft 230 may be rotatably mounted in the sleeve 220. Meanwhile, the shaft 230 is the same component as the shaft 130 included in the spindle motor 100 according to the embodiment of the present invention described above. Therefore, a detailed description thereof will be omitted below and be replaced by the above-mentioned description.

The rotor hub 240 may be fixedly mounted on an upper portion of the shaft 230 so as to be disposed on an upper portion of the thrust plate 260.

In addition, the rotor hub 240 may include a body 242 having a mounting hole 242a formed therein so that the shaft 230 may be mounted therein while penetrating therethrough, and a magnet mounting part 244 extended downwardly from an edge of the body 242 in an axial direction.

In addition, the magnet mounting part 244 includes a magnet 203 mounted on an inner surface thereof, wherein the magnet 203 may be disposed to face an end of the stator core 202.

The cover member 250 may be mounted on a lower end portion of the sleeve 220 and include an opening/closing part 252 formed therein, wherein the opening/closing part 252 opens and closes the circulation hole 250.

Meanwhile, the cover member 250 is the same component as the cover member 150 included in the spindle motor 100 according to the embodiment of the present invention described above. Therefore, a detailed description thereof will be omitted below and be replaced by the above-mentioned description.

The thrust plate 260 may be fixedly mounted to the shaft 230 and disposed at an upper portion of the sleeve 220. In addition, the thrust plate 260 may rotate together with the shaft 230 at the time of the rotation of the shaft 230. In addition, the thrust plate 260 may be floated together with the shaft 230 at the time of the rotation of the shaft 230.

Meanwhile, a thrust dynamic pressure groove (not shown) may be formed in at least one of the thrust plate 260 and an upper surface of the sleeve 220 so that thrust fluid dynamic pressure may be generated. That is, floating force with which the shaft 230 is floated may be provided by the fluid dynamic pressure generated by the thrust dynamic pressure groove.

The cap member 270 may be fixedly mounted to the sleeve 220 so as to be disposed at an upper portion of the thrust plate 260, and an interface between the lubricating fluid and air, that is, a liquid-vapor interface may be formed between an upper surface of the thrust plate 260 and the cap member 270.

To this end, the cap member 270 may include an inclined surface. That is, the cap member 270 may include the inclined surface formed on a lower surface thereof so that the liquid-vapor interface may be formed by a capillary phenomenon.

As described above, the opening/closing part 252 closes a lower end portion of the circulation hole 222 at the time of initial driving of the shaft 230 to thereby allow the pressure in the bearing clearance B3 to rapidly increase. Therefore, a floating time of the shaft 230 may be reduced.

In addition, the shaft 230 may be easily floated even when the shaft 230 rotates at a low speed.

In addition, at the time of stop of the shaft 230, a lower surface of the thrust plate 260 and the upper surface of the sleeve 220 are in a state in which they are in contact with each other. Thereafter, at the time of the rotation of the shaft 230, the thrust plate 260 and the shaft 230 are floated. As described above, the floating time of the shaft 230 is reduced, whereby abrasion of the thrust plate 260 may be reduced.

Hereinafter, a spindle motor according to another embodiment of the present invention will be described with reference to the accompanying drawings. However, a detailed description of the same components as the components described in the embodiment of the present invention described above will be omitted and be replaced with the above-mentioned description.

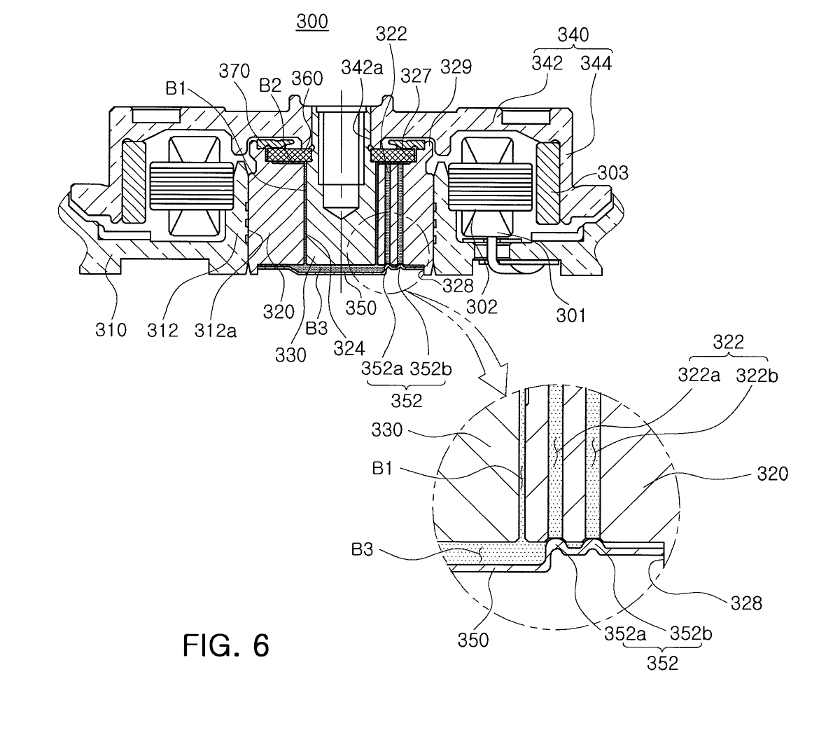

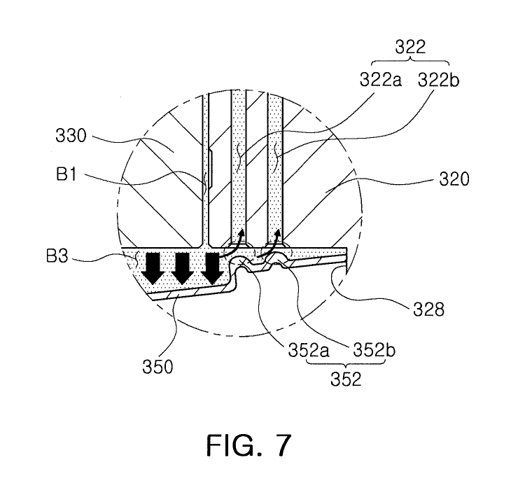

FIG. 6 is a cross-sectional view schematically showing a spindle motor according to another embodiment of the present invention; and FIGS. 7 is a view describing an operation of a spindle motor according to another embodiment of the present invention.

Referring to FIGS. 6 and 7, a spindle motor 300 according to another embodiment of the present invention may include, for example, a base member 310, a sleeve 320, a shaft 330, a rotor hub 340, a cover member 350, a thrust plate 360, and a cap member 370.

Meanwhile, the base member 310, the shaft 330, the rotor hub 340, the thrust plate 360, and the cap member 370 are the same components as the base member 210, the shaft 230, the rotor hub 240, the thrust plate 260, and the cap member 270 included in the spindle motor 200 according to another embodiment of the present invention described above. Therefore, a detailed description thereof will be omitted below.

In addition, configurations included in the sleeve 320 and the cover member 350 are also the same as those of the sleeve 120 and the cover member 150 included in the spindle motor 100 according to the embodiment of the present invention described above with the exception of configurations to be described below.

That is, only configurations included in the sleeve 320 and the cover member 350 different from the configurations included in the sleeve 220 and the cover member 250 of the spindle motor 200 according to another embodiment of the present invention described above will be described below.

The sleeve 320 may include a plurality of circulation holes 322 formed therein. In addition, the plurality of circulation holes 322 may be formed in a radial direction. The circulation hole 322 may include a first circulation hole 322a and a second circulation hole 322b formed outside the first circulation hole 322a in the radial direction.

Meanwhile, although the present embodiment describes a case in which two circulation holes 322 are provided by way of example, the present invention is not limited thereto. Two or more circulation holes 322 may also be formed.

The cover member 350 includes opening/closing parts 352 formed therein, wherein the opening/closing parts 352 open and close the circulation holes 322. The opening/closing parts 352 have the number corresponding to the number of circulation holes 322.

That is, the opening/closing part 352 may include a first opening/closing part 352a opening/closing the first circulation hole 322a and a second opening/closing part 352b opening/closing the second circulation hole 322b.

Meanwhile, the second opening/closing part 352b serves to maintain a state in which it closes a lower end portion of the second circulation hole 322b under a normal driving condition and open the second circulation hole 322b when pressure in a bearing clearance B3 excessively increases.

Therefore, excessive increase in the pressure in the bearing clearance B3 may be suppressed, whereby excessive floating of the shaft 330 under a low temperature environmental condition may be suppressed.

An operation of the cover member 350 will be described in more detail. First, at the time of stop of the shaft 330, the first and second opening/closing parts 352a and 352b of the cover member 350 are in a state in which they close lower end portions of the first and second circulation holes 322a and 322b of the sleeve 320.

Thereafter, at the time of initial driving of the shaft 330, the first and second opening/closing parts 352a and 352b of the cover member 350 also maintain a state in which they close the lower end portions of the first and second circulation holes 322a and 322b of the sleeve 320.

In addition, when the pressure in the bearing clearance B3 arrives at pressure capable of floating the shaft 330, the cover member 350 is elastically deformed, such that the first opening/closing part 352a opens the first circulation hole 322a. At this time, the second opening/closing part 352b maintains a state in which it closes the second circulation hole 322b.

That is, the second opening/closing part 352b maintains a state in which it closes the second circulation hole 322b under a normal driving condition.

As described above, since the state in which the first and second circulation holes 322a and 322b are closed may be maintained until the shaft 330 is floated, the floating time of the shaft 330 may be reduced.

Meanwhile, when the pressure in the bearing clearance B3 excessively increases, the cover member 350 may be more elastically deformed according to the increase in the pressure. In this case, the second opening/closing part 352b may open the second circulation hole 322b.

Therefore, the excessive floating of the shaft 330 due to an excessive increase in the pressure in the bearing clearance B3 under a low temperature environmental condition may be suppressed.

As set forth above, according to the embodiment of the present invention, at the time of the initial driving of the shaft, the circulation hole may be closed by the cover member including the opening/closing part opening and closing the circulation hole to reduce the pressure increase time, whereby the shaft may be easily floated even at the time of low speed rotation.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve including a shaft rotatably mounted therein and a circulation hole formed therein; and
a cover member mounted on a lower end portion of the sleeve and including an opening/closing part opening and closing the circulation hole.

2. The spindle motor of claim 1, wherein the cover member is formed of a material having elasticity so that the opening/closing part may open and close the circulation hole.

3. The spindle motor of claim 1, wherein the opening/closing part is formed of a protrusion inserted into an inner portion of the circulation hole.

4. The spindle motor of claim 1, wherein the circulation hole includes a chamfer part formed at a lower end portion thereof so that the opening/closing part may be easily inserted thereinto.

5. The spindle motor of claim 1, wherein the sleeve includes upper and lower dynamic pressure grooves formed in an inner peripheral surface thereof so that fluid dynamic pressure is generated through lubricating fluid filling a bearing clearance formed by the shaft and the sleeve at the time of rotation of the shaft, and
the lubricating fluid filling the bearing clearance moves from the bearing clearance to a bearing clearance formed by the cover member and the shaft and by the cover member and the sleeve at the time of the rotation of the shaft.

6. The spindle motor of claim 1, wherein the sleeve includes a plurality of circulation holes formed therein in a radial direction, and
a plurality of opening/closing parts corresponding to the plurality of circulation holes are provided so as to open and close the plurality of circulation holes.

7. The spindle motor of claim 1, further comprising a thrust plate fixedly mounted to the shaft so as to be disposed at an upper portion of the sleeve.
